(19) United States
(12) Patent Application Publication
(10) Pub. No.: US 2026/0048619 A1
(43) Pub. Date: Feb. 19, 2026

(54) Fluid Conduit for Use in a Tire Inflation System

(71) Applicant: ArvinMeritor Technology, LLC, Troy, MI (US)

(72) Inventor: Bryan D. HACKETT, Davisburg, MI (US)

(21) Appl. No.: 18/805,057

(22) Filed: Aug. 14, 2024

(51) Int. Cl. B60C 23/00

(52) U.S. Cl. CPC B60C 23/00381; B60C 23/00345

(57) ABSTRACT

An apparatus for use in a tire inflation system may include a steer-axle spindle, wherein the steer-axle spindle may include a first side, a second side, and a channel formed in the steer-axle spindle through the first side and the second side. A fluid conduit may be configured to be disposed through the channel from the first side of the steer-axle spindle to the second side of the steer-axle spindle, wherein a first end of the fluid conduit may be configured to be in fluid communication with a rotary union, and a second end of the fluid conduit may be configured to be in fluid communication with an air supply for the tire inflation system.

### BACKGROUND

Tire inflation systems, e.g., those used primarily on trucks and/or trailers, use compressed air to inflate the tires. Some tire inflation systems use a pressurized channel approach, which has numerous limitations.

### SUMMARY

In one example implementation, a method for a tire inflation system may include but is not limited to forming a steer-axle spindle, wherein the steer-axle spindle may include a first side, a second side, and a channel formed in the steer-axle spindle through the first side and the second side. A fluid conduit may be fabricated that is configured to be disposed through the channel from the first side of the steer-axle spindle to the second side of the steer-axle spindle, wherein a first end of the fluid conduit may be configured to be in fluid communication with a rotary union, and a second end of the fluid conduit may be configured to be in fluid communication with an air supply for the tire inflation system.

One or more of the following example features may be included. The channel may include a non-sealing bushing disposed in proximity to the second end of the fluid conduit. A material may be provided encompassing the fluid conduit configured to seal the channel. A pass-through fitting may be provided that is configured to allow the fluid conduit to slidingly pass-through the channel. A pass-through fitting may be provided that is configured to provide a seal between the fluid conduit and the pass-through fitting. A pass-through fitting may be provided that is configured to provide a seal between the pass-through fitting and the channel. The fluid conduit may be one of rigid and flexible. The fluid conduit may be fabricated from nylon. The fluid conduit may be fabricated from Polytetrafluoroethylene (PTFE). A fluid passage may be formed in the rotary union, wherein the fluid conduit may be in fluid communication with the fluid passage, and wherein an air conduit may be provided that is operatively connected to the rotary union in fluid communication with the fluid passage.

In another example implementation, an apparatus for use in a tire inflation system may include but is not limited to a steer-axle spindle, wherein the steer-axle spindle may include a first side, a second side, and a channel formed in the steer-axle spindle through the first side and the second side. A fluid conduit may be configured to be disposed through the channel from the first side of the steer-axle spindle to the second side of the steer-axle spindle, wherein a first end of the fluid conduit may be configured to be in fluid communication with a rotary union, and a second end of the fluid conduit may be configured to be in fluid communication with an air supply for the tire inflation system.

One or more of the following example features may be included. The apparatus may further include a non-sealing bushing disposed in proximity to the second end of the fluid conduit. The apparatus may further include a material encompassing the fluid conduit configured to seal the channel. The apparatus may further include a pass-through fitting configured to allow the fluid conduit to slidingly pass through the channel. The apparatus may further include a pass-through fitting configured to provide a seal between the fluid conduit and the pass-through fitting. The apparatus may further include a pass-through fitting configured to provide a seal between the pass-through fitting and the channel. The fluid conduit may be one of rigid and flexible. The fluid conduit may be fabricated from nylon. The fluid conduit is fabricated from Polytetrafluoroethylene (PTFE). The rotary union may comprise a fluid passage formed therein, wherein the fluid conduit may be in fluid communication with the fluid passage, and wherein the apparatus may further comprise an operatively connected to the rotary union in fluid communication with the fluid passage.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of an apparatus for use in a tire inflation system according to one or more example implementations of the disclosure;

FIG. 2 is an example diagrammatic view of a non-sealing bushing for use in a tire inflation system according to one or more example implementations of the disclosure;

FIG. 3 is an example diagrammatic view of a pass-through fitting for use in a tire inflation system according to one or more example implementations of the disclosure; and

FIG. 4 is an example flowchart for part of a tire inflation system is shown according to one or more example implementations of the disclosure.

Like reference symbols in the various drawings may indicate like elements.

### DESCRIPTION

Automatic Tire Inflation systems (ATIS) deliver compressed air to tires (e.g., on trucks and/or trailers. Typically, at least for the front steer axle, air delivery goes either through the center of the spindle to the wheel-end, or through a complicated air/oil seal. Some solutions using a pressurized channel approach through the center of the spindle have two example and non-limiting disadvantages.

For instance, these solutions generally require the inboard side of the spindle channel to be sealed to ensure air pressure is sealed into the channel. As another example, these systems are not as effective at making quick corrective actions to the tire pressure, as there is not a direct air connection to the rotary union. Therefore, as will be discussed in greater detail below, the present disclosure describes a fluid conduit (e.g., an air line) that is directly routed through the center of the steer-axle spindle and directly to a rotary union mounted on the hubcap.

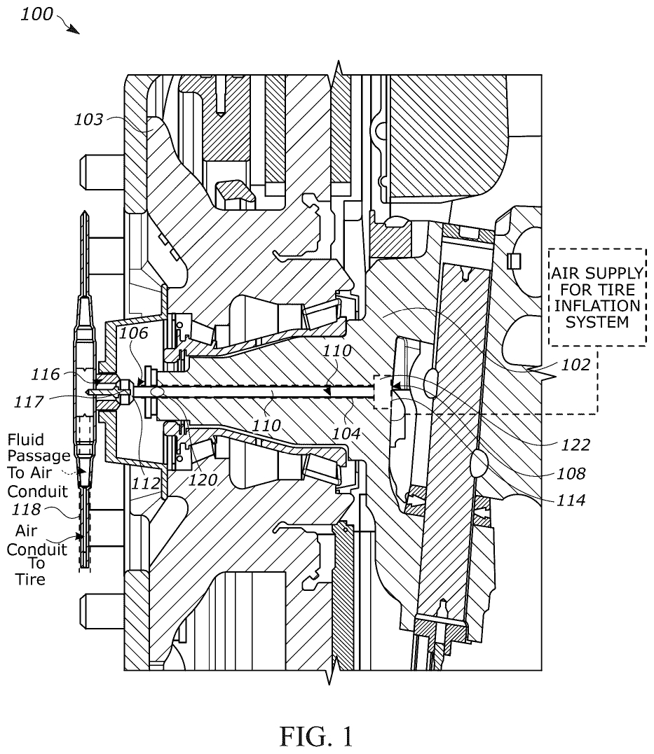

As discussed above and referring also at least to the example implementations of FIGS. 1-4, an apparatus for use in a tire inflation system may include a steer-axle spindle, wherein the steer-axle spindle may include a first or outboard side, a second or inboard side, and a channel formed in the steer-axle spindle through the first side and the second side. A fluid conduit may be configured to be disposed through the channel from the first side of the steer-axle spindle to the second side of the steer-axle spindle, wherein a first end of the fluid conduit may be configured to be in fluid communication with a rotary union, and a second end of the fluid conduit may be configured to be in fluid communication with an air supply for the tire inflation system.

As noted above and referring at least to the example implementation of FIG. 1, an apparatus (e.g., apparatus 100) for use in a tire inflation system may include a steer-axle spindle (e.g., steer-axle spindle 102). As known in the art, steer-axle spindle 102 is a component in the steering system of a vehicle (e.g., trucks, trailers, and other heavy-duty vehicles), which is part of the front axle assembly and plays a role in allowing the vehicle's wheels to turn, thus enabling steering. In addition, steer-axle spindle 102 supports a wheel hub 103, enables smooth rotation, and ensures the alignment and stability of the vehicle. In some implementations, steer-axle spindle 102 may include machined features such as bearing seats, threads, and flanges, mounting points for the wheel hub and other components of the steering system, a kingpin that connects the spindle to the axle beam or steering knuckle, a bore for the kingpin, which acts as a pivot point, bearing seats, which allow the wheel hub to rotate around steer-axle spindle 102, threads and flanges, which are used for attaching various components securely, such as brake parts and suspension elements. Additionally, though FIG. 1 shows a particular implementation of a steer-axle spindle 102, those skilled in the art will appreciate that such spindles come in a wide variety of shapes and sizes and that the teachings of the instant disclosure are equally applicable to such alternative spindle configurations.

In some implementations, the steer-axle spindle includes a first or outboard side 106, a second or inboard side 108, and a channel formed in the steer-axle spindle through the first side 106 and the second side 108. For instance, steer-axle spindle 102 is shown with a spindle channel (e.g., spindle channel 104 shown with dashed lines), spanning the first side 106 of steer-axle spindle 102 (e.g., the sealed and/or unsealed inner end of channel 104) to a second side 108 of steer-axle spindle 102 (e.g., the inboard end of spindle channel 104).

In some implementations, a fluid conduit may be configured to be disposed through the channel from the first side of the steer-axle spindle to the second side of the steer-axle spindle. For example, as shown in FIG. 1, apparatus 100 may include a fluid conduit (e.g., fluid conduit 110), which may be an air hose. In the example of FIG. 1, fluid conduit 110 is disposed through spindle channel 104 from first side 106 to second side 108 of steer-axle spindle 102.

In some implementations, fluid conduit 110 may be rigid or flexible (as shown), or some portions may be rigid while other portions are flexible. Flexibility may generally be described as the ability to bend and conform to different shapes and paths (e.g., with materials such as rubber, flexible plastics, composite materials, etc.), whereas rigidity may generally be described as an inability to bend and conform to different shapes and paths (e.g., with materials such as metal and rigid plastics, etc.). Regardless of the specific flexibility or rigidity of fluid conduit 110, it should generally be configured such that it can be fed through spindle channel 104 from the first side to the second side, or vice versa. In some implementations, fluid conduit 110 may be fabricated from nylon, Polytetrafluoroethylene (PTFE), or other material (e.g., neoprene, Ethylene Propylene Diene Monomer, Thermoplastic Elastomers such as Polyvinyl Chloride or Polyurethane, etc.). It will be appreciated after reading the present disclosure that any material capable of being used in a tire inflation system may be used without departing from the scope of the present disclosure. As such, the use of the materials disclosed for the fluid conduit 110 should be taken as example only and not to otherwise limit the scope of the present disclosure.

In some implementations, a first end of the fluid conduit may be configured to be in fluid communication with a rotary union, and a second end of the fluid conduit may be configured to be in fluid communication with an air supply for the tire inflation system. For instance, as shown in FIG. 1, fluid conduit 110 is shown with first end 112 and second end 114. In the example, first end 112 of fluid conduit 110 is in fluid communication with a rotary union (e.g., rotary union 116), and second end 114 of fluid conduit 110 is in fluid communication with an air supply for the tire inflation system. By making the first and second ends 112, 114 of fluid conduit 110 resistant to fluid leaks, the provision of fluid conduit 110 eliminates the need, often attendant to prior art systems, to provide fluid-tight seals at either end of spindle channel 110 itself. This, in turn, simplifies the construction of automatic tire inflation systems in accordance with some aspects of the instant disclosure.

As known in the art of automatic tire inflation systems, a rotary union operates to permit the flow of a fluid from stationary supply source to rotating machinery. Thus, rotary union 116 comprises fluid passage 117 formed therein, wherein fluid conduit 110 may be in fluid communication with the fluid passage 117, and wherein the apparatus may further comprise an air conduit (e.g., air conduit 118) operatively connected to rotary union 116 in fluid communication with fluid passage 117. For example, in some implementations, the air supply may be a pressurized gas source that can supply and/or store a volume of pressurized gas or a gas mixture, such as air or nitrogen. This source might include a tank or a compressor, which could be powered by the vehicle's engine or power source. Positioned on the vehicle, the gas source can deliver pressurized gas or a gas mixture at a pressure that meets or exceeds the required inflation pressure of a tire. As used herein, the term “pressurized gas” encompasses both pressurized gases and gas mixtures.

A suspension gas supply subsystem generally connects the pressurized gas source to one or more tires. This subsystem may consist of one or more conduits (such as fluid conduit 110), that channel pressurized gas to the tires via control valves that regulate the flow to and from the tires. The subsystem may also include a vent valve to release pressurized gas from a tire and its conduit to the atmosphere. The configurations of conduits, control valves, and exhaust valves are examples, and variations may exist, such as a single conduit servicing multiple tires or multiple exhaust valves connected to tires and/or conduits.

In some implementations, the tire inflation system can inflate, deflate, and check the pressure of one or more tires by providing/releasing pressurized gas or a gas mixture to the tires. This system may be connected to the pressurized gas source and may include a gas supply subsystem and a controller (e.g., an electronic controller unit or ECU). The gas supply subsystem links the gas source to the tires through the fluid conduit(s) (e.g., air conduit 118—such as hoses, tubes, pipes, etc.), delivering pressurized gas to the tires. The depicted conduit configuration is just an example, as a single conduit might service each tire individually rather than multiple tires.

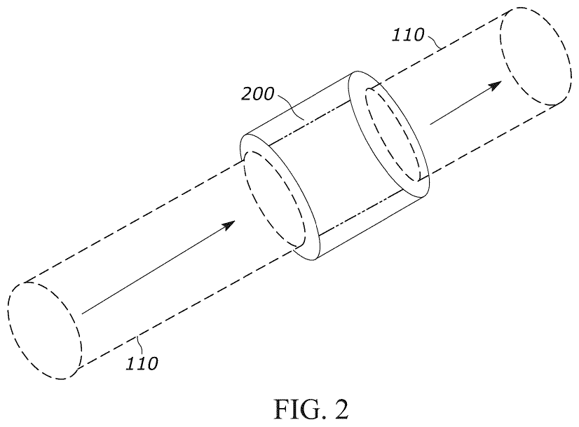

In some implementations, apparatus 100 may further include an element (e.g., element 122), as shown in FIG. 1. An example of element 122 is a non-sealing bushing disposed in proximity to the second end of the fluid conduit. For instance, and referring at least to the example implementations of FIGS. 1-2, second side 108 of steer-axle spindle 102 (e.g., the inboard end of spindle channel 104) may include element 122 (e.g., a non-sealing bushing disposed in proximity to second end 114 of fluid conduit 110). An example non-sealing bushing (e.g., non-sealing bushing 200) is shown in FIG. 2. Non-sealing bushing 200 may serve several important functions, such as friction reduction, load support, vibration dampening, etc. It will be appreciated after reading the present disclosure that a sealing bushing may also be used without departing from the scope of the present disclosure. Generally, non-sealing bushing 200 may have a cylindrical shape, with a consistent diameter along its length. Non-sealing bushing 200 may also have both inner and outer surfaces that are smooth to allow for easy movement and to minimize friction between the bushing and the shaft or housing. In some implementations, non-sealing bushing 200 may be made from durable materials such as bronze, brass, steel, or various polymers like nylon or PTFE. The ends of the bushing may be chamfered or beveled to facilitate easier insertion into the housing and to prevent damage to the shaft or housing. As an example and non-limiting advantage, non-sealing brushing 200 does not need to seal spindle channel 104, since spindle channel 104 is not pressurized like other systems. The channel is a conduit for routing the air line, and non-sealing bushing 200 helps support the air line as it enters spindle channel 104, protecting it from vibration damage, friction damage, etc.

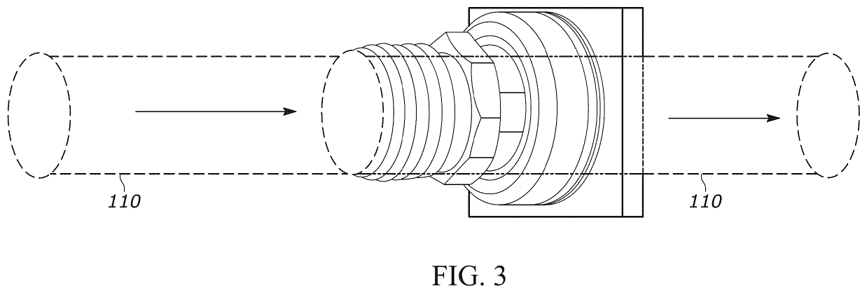

In some implementations, element 122 from FIG. 1 may be a pass-through fitting. An example pass-through fitting (e.g., pass-through fitting 300) is shown in FIG. 3. For instance, apparatus 100 may further include a pass-through fitting configured to (1) allow fluid conduit 110 to slidingly pass through spindle channel 104, (2) provide a seal between fluid conduit 110 and the pass-through fitting, and/or (3) provide a seal between the pass-through fitting and spindle channel 104. For instance, and referring at least to the example implementations of FIG. 1 and FIG. 3, second side 108 of steer-axle spindle 102 (e.g., the inboard end of spindle channel 104) is shown including element 122 (e.g., a pass-through fitting 300 shown in FIG. 3) to allow fluid conduit 110 to slidingly pass-through spindle channel 104, to provide a seal between fluid conduit 110 and pass-through fitting 300, and to provide a seal between pass-through fitting 300 and spindle channel 104. Generally, a pass-through fitting is a type of connector used in various piping and tubing systems to allow fluid (e.g., liquid, gas) to pass through a barrier, such as a wall, bulkhead, or panel, while maintaining a secure and leak-proof connection, ensuring that the fluid conduits used stay in place and do not move or become disconnected. Pass-through fittings may be made from various materials, such as stainless steel, brass, plastic, or other metals. An example pass-through fitting is a panel-mount fitting, although any pass-through fitting capable of accomplishing the present disclosure may be used.

In some implementations, second side 108 of steer-axle spindle 102 (e.g., the inboard end of spindle channel 104) may include a fitting that seals spindle channel 104 and connects another fluid conduit outside of steer-axle spindle 102. An example sealing bushing (as opposed to non-sealing bushing 200) may be used.

In some implementations, the apparatus may further include a material encompassing the fluid conduit configured to seal the channel. For instance, second side 108 of steer-axle spindle 102 (e.g., the inboard end of spindle channel 104) may include a material encompassing (surrounding) some or all of fluid conduit 110 to seal spindle channel 104. In some implementations, the material (e.g., material 120) may be flexible, durable, and capable of providing a tight seal to prevent leaks and protect against contaminants. Example materials may include rubber (e.g., Ethylene Propylene Diene Monomer, Neoprene, Silicone), thermoplastic elastomers (e.g., Thermoplastic Polyurethane, Polyvinyl Chloride), foam materials (e.g., Closed-Cell Foam), Polytetrafluoroethylene, Metal Clamps with Sealing Inserts (e.g., rubber or silicone inserts), Heat-Shrink Tubing (e.g., polyolefin), Adhesive-Lined Heat-Shrink Tubing, etc.

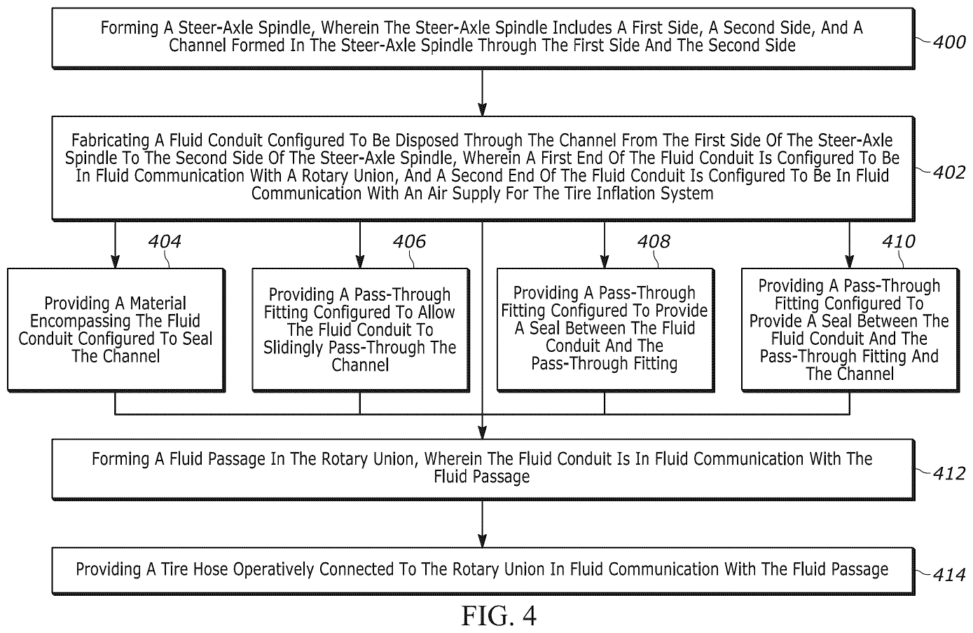

Referring at least to the example implementation of FIG. 4, an example flowchart for part of a tire inflation system is shown. It will be appreciated after reading the present disclosure that any known machinery and manufacturing processes for carrying out the present disclosure may be used without departing from the scope of the present disclosure. For example, CNC machines, forging equipment, heat treatment furnaces, grinding machines, drilling/boring machines, threading machines, welding equipment, etc. may be used.

At box 400, in some implementations, a steer-axle spindle may be formed, wherein the steer-axle spindle may include a first side, a second side, and a channel formed in the steer-axle spindle through the first side and the second side. In some implementations, the channel may include non-sealing bushing disposed in proximity to the second end of the fluid conduit.

At box 402, in some implementations, a fluid conduit may be fabricated that is configured to be disposed through the channel from the first side of the steer-axle spindle to the second side of the steer-axle spindle, wherein a first end of the fluid conduit may be configured to be in fluid communication with a rotary union, and a second end of the fluid conduit may be configured to be in fluid communication with an air supply for the tire inflation system. The fluid conduit may be either rigid, flexible, or a combination thereof. The fluid conduit may be fabricated from nylon. The fluid conduit may be fabricated from Polytetrafluoroethylene (PTFE).

At box 404, in some implementations, a material may be provided encompassing the fluid conduit configured to seal the channel. At box 406, in some implementations, a pass-through fitting may be provided that is configured to allow the fluid conduit to slidingly pass-through the channel. At box 408, in some implementations, a pass-through fitting may be provided that is configured to provide a seal between the fluid conduit and the pass-through fitting. At box 410, in some implementations, a pass-through fitting may be provided that is configured to provide a seal between the pass-through fitting and the channel.

At box 412, in some implementations, a fluid passage may be formed in the rotary union, wherein the fluid conduit may be in fluid communication with the fluid passage. At box 414, in some implementations, an air conduit may be provided that is operatively connected to the rotary union in fluid communication with the fluid passage.

It will be appreciated after reading the present disclosure that any standard equipment and/or manufacturing processes may be used singly or in any combination with the processes of the present disclosure. For example, CNC machines, forging equipment, heat treatment furnaces, grinding machines, drilling/boring machines, threading machines, welding equipment, etc. may be used. In one or more example implementations, the respective equipment, flowcharts and/or processes described herein may be manually implemented, computer-implemented, or a combination thereof.

In some implementations, the flowchart and block diagrams in the figures illustrate the architecture, functionality, and operation of possible implementations of apparatus (systems), methods according to various implementations of the present disclosure. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. An apparatus for use in a tire inflation system comprising:
a steer-axle spindle, wherein the steer-axle spindle includes a first side, a second side, and a channel formed in the steer-axle spindle through the first side and the second side; and
a fluid conduit configured to be disposed through the channel from the first side of the steer-axle spindle to the second side of the steer-axle spindle, wherein a first end of the fluid conduit is configured to be in fluid communication with a rotary union, and a second end of the fluid conduit is configured to be in fluid communication with an air supply for the tire inflation system.

2. The apparatus of claim 1 further comprising a non-sealing bushing disposed in proximity to the second end of the fluid conduit.

3. The apparatus of claim 1 further comprising a material encompassing the fluid conduit configured to seal the channel.

4. The apparatus of claim 1 further comprising a pass-through fitting configured to allow the fluid conduit to slidingly pass through the channel.

5. The apparatus of claim 1 further comprising a pass-through fitting configured to provide a seal between the fluid conduit and the pass-through fitting.

6. The apparatus of claim 1 further comprising a pass-through fitting configured to provide a seal between the pass-through fitting and the channel.

7. The apparatus of claim 1, wherein the fluid conduit is one of rigid and flexible.

8. The apparatus of claim 1, wherein the fluid conduit is fabricated from nylon.

9. The apparatus of claim 1, wherein the fluid conduit is fabricated from Polytetrafluoroethylene (PTFE).

10. The apparatus of claim 1, wherein the rotary union comprises a fluid passage formed therein and wherein the fluid conduit is in fluid communication with the fluid passage, the apparatus further comprising:
an air conduit operatively connected to the rotary union in fluid communication with the fluid passage.

11. A method for a tire inflation system comprising:
forming a steer-axle spindle, wherein the steer-axle spindle includes a first side, a second side, and a channel formed in the steer-axle spindle through the first side and the second side; and
fabricating a fluid conduit configured to be disposed through the channel from the first side of the steer-axle spindle to the second side of the steer-axle spindle, wherein a first end of the fluid conduit is configured to be in fluid communication with a rotary union, and a second end of the fluid conduit is configured to be in fluid communication with an air supply for the tire inflation system.

12. The method of claim 11 further comprising a non-sealing bushing disposed in proximity to the second end of the fluid conduit.

13. The method of claim 11 further comprising providing a material encompassing the fluid conduit configured to seal the channel.

14. The method of claim 11 further comprising providing a pass-through fitting configured to allow the fluid conduit to slidingly pass through the channel.

15. The method of claim 11 further comprising providing a pass-through fitting configured to provide a seal between the fluid conduit and the pass-through fitting.

16. The method of claim 11 further comprising providing a pass-through fitting configured to provide a seal between the pass-through fitting and the channel.

17. The method of claim 11, wherein the fluid conduit is one of rigid and flexible.

18. The method of claim 11, wherein the fluid conduit is fabricated from nylon.

19. The method of claim 11, wherein the fluid conduit is fabricated from Polytetrafluoroethylene (PTFE).

20. The method of claim 11 further comprising:
forming a fluid passage in the rotary union, wherein the fluid conduit is in fluid communication with the fluid passage; and
providing an air conduit operatively connected to the rotary union in fluid communication with the fluid passage.
